(19) United States
(12) Patent Application Publication
(10) Pub. No.: US 2016/0133936 A1
(43) Pub. Date: May 12, 2016

(54) NEGATIVE MATERIAL LAYER AND LITHIUM-ION BATTERY APPLYING THE SAME

(71) Applicant: DONGGUAN AMPEREX TECHNOLOGY LIMITED, Dongguan (CN)

(72) Inventors: Zheng CAO, Dongguan (CN); Qiang Zheng, Dongguan (CN); Shengwei Wang, Dongguan (CN); Chengdong Sun, Dongguan (CN); Hongguang Shen, Dongguan (CN); Chao Gao, Dongguan (CN)

(21) Appl. No.: 14/928,825

(22) Filed: Oct. 30, 2015

(30) Foreign Application Priority Data
Nov. 6, 2014 (CN) 201410624755.9

(51) Int. Cl. H01M 4/62; H01M 4/134; H01M 4/485; H01M 4/38; H01M 4/587; H01M 4/133; H01M 4/131

(52) U.S. Cl. CPC H01M 4/622; H01M 4/133; H01M 4/134; H01M 4/131; H01M 4/387; H01M 4/386; H01M 4/587; H01M 4/485; H01M 2004/027

(57) ABSTRACT

The present disclosure provides a negative material layer, which comprises negative active material, conductive agent, binder material and thickening agent. A weight percentage of the binder material in the negative material layer is not more than 2%. The binder material comprises a polymer polymerized from a styrene monomer, an acrylic ester monomer and an acrylic acid monomer. The negative material layer has a small amount of binder material, an excellent ion conductivity; the lithium-ion battery using the negative material layer can avoid lithium precipitation from occurring on a surface of the negative electrode and have an excellent safety performance and an excellent cycle performance in the case of quick and high rate charge.

### CROSS-REFERENCE TO RELATED APPLICATIONS

The present application claims priority to Chinese patent application No. CN201410624755.9, filed on Nov. 6, 2014, which is incorporated herein by reference in its entirety.

### FIELD OF THE PRESENT DISCLOSURE

The present disclosure relates to a field of a lithium-ion battery technology, and more specifically relates to a negative material layer and a lithium-ion battery applying the same which can be quickly charged under a high rate.

### BACKGROUND OF THE PRESENT DISCLOSURE

The lithium-ion battery has become an ideal power source for mobile devices, due to advantages, such as a high energy density, a high operating voltage, a long cycle life, none memory effect, environment friendly and the like, and the lithium-ion battery has replaced the conventional power source. With developments of intelligential and multi-functional mobile devices, power consumption of the intelligential and multi-functional mobile devices are significantly increased, people present higher requirements on the lithium-ion battery in energy density.

Ever since Sony Corporation develops a lithium-ion battery using graphite as the negative active material in 1991, the energy density of the lithium-ion battery using graphite has been already near its limits after more than 20 years of development. Certain key problems are still needed to resolve in the development of new chemical systems, such as powdering of silicon-based negative active material itself due to expansion in cycle process, a poor high temperature cycle performance of the positive active material under a high voltage, a poor stability of the electrolyte under a high voltage, gas production due to reactions between the positive active material and the electrolyte and the like.

Since the promotion of the energy density reaches a plateau, in order to improve the user experience, a lithium-ion battery which can be quickly charged under a high rate is developed to properly compensate insufficiency of the energy density. However, when the lithium-ion battery is quickly charged under a high rate, polarization of the lithium-ion battery increases, current per unit area increases, the negative electrode plate quickly reaches the electric potential of lithium precipitation, therefore a large amount of lithium ions diffusing from the positive material layer towards the negative material layer cannot be absorbed by the negative material layer in time, lithium dendrite will be precipitated on the surface of the negative electrode plate, capacity of the lithium-ion battery fast decays, and the lithium dendrite easily penetrates the separator, thereby resulting in great security risk.

A negative electrode plate of the lithium-ion battery which uses distilled water as the solvent generally uses styrene-1,3-butadiene rubber (SBR) aqueous emulsion as the binder material, the binder material has excellent elasticity, excellent adhesive force, but ionic conductivity of the binder material is poor, therefore the lithium-ion battery using such a binder material cannot be quickly charged under a high rate.

### SUMMARY OF THE PRESENT DISCLOSURE

In a first aspect of the present disclosure, the present disclosure provides a negative material layer, the negative material layer has a small amount of binder material, an excellent ion conductivity; the lithium-ion battery using the negative material layer can avoid lithium precipitation occurring on a surface of the negative electrode and have an excellent safety performance and an excellent cycle performance in the case of quick and high rate charge.

The negative material layer comprises negative active material, conductive agent, binder material and thickening agent, a weight percentage of the binder material in the negative material layer is not more than 2%; the binder material comprises a polymer polymerized from a styrene monomer, an acrylic ester monomer and an acrylic acid monomer.

In an embodiment, the acrylic ester monomer has a chemical structural formula illustrated in formula (I), the acrylic acid monomer has a chemical structural formula illustrated in formula (II);

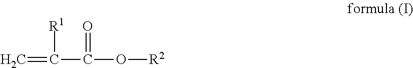

in formula (I), R¹ is selected from H or alkyl group having 1˜20 carbon atoms; R² is selected from alkyl group having 1˜20 carbon atoms;

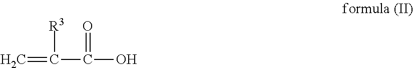

in formula (II), R³ is selected from H or alkyl group having 1˜20 carbon atoms.

In an embodiment, in formula (I), preferably, R¹ is selected from H or alkyl group having 1˜10 carbon atoms.

In an embodiment, in formula (II), preferably, R³ is selected from H or alkyl group having 1˜10 carbon atoms.

In an embodiment, the negative material layer is comprised of the negative active material, the conductive agent, the binder material and the thickening agent.

The alkyl group of R¹, R² and R³ refers to a remaining group of straight-chain alkanes, branch-chain alkanes or cycloalkanes with one hydrogen atom dehydrogenated.

In an embodiment, the acrylic ester monomer is at least one select from a group consisting of methyl acrylate, ethyl acrylate, butyl methacrylate and butyl acrylate; the acrylic acid monomer is at least one select from a group consisting of acrylic acid, methacrylic acid and ethacrylic acid.

In an embodiment, the weight percentage of the binder material in the negative material layer is 0.5˜2%. Preferably, the weight percentage of the binder material in the negative material layer is 1˜2%. The binder material has a high adhesive force and an excellent ionic conductivity, thereby significantly decreasing the polarization on the surface of the negative electrode plate.

In an embodiment, a weight percentage of the styrene monomer in whole monomers forming the bind material is 10˜40%. Preferably, an upper limit of the weight percentage of the styrene monomer in the whole monomers is 35%, 30% or 25%, a lower limit of the weight percentage of the styrene monomer in the whole monomers is 12% or 15%. The using of the styrene monomer can improve the cohesive force in the polymer of the binder material, thereby increasing the adhesive force of the binder material.

In an embodiment, a weight percentage of the acrylic ester monomer in the whole monomers is 50˜85%. Preferably, an upper limit of the weight percentage of the acrylic ester monomer in the whole monomers is 85%, 82%, 80% or 78%, a lower limit of the weight percentage of the acrylic ester monomer in the whole monomers is 60%, 65%, 70% or 72%. The using of the acrylic ester monomer ensures an excellent adhesion between the negative material particles in the negative material layer and a current collector of the negative electrode plate, at the same time a complexation-decomplexation process between unshared pair electrons in the carbonyl group of the acrylic ester monomer and the lithium ions under the electric field effect makes the lithium ions quickly transfer through the polymer chain segment, thereby making the binder material having an excellent ionic conductivity.

In an embodiment, a weight percentage of the acrylic acid monomer in the whole monomers is 1˜10%. Preferably, an upper limit of the weight percentage of the acrylic acid monomer in the whole monomers is 8%, 7% or 6%, a lower limit of the weight percentage of the acrylic acid monomer in the whole monomers is 2%, 3% or 4%. By grafting hydrophilic groups (such as carboxyl group) on the side chain of the polymer of the binder material, the surface energy of the binder material is decreased, and the emulsion of the bind material is easily dried to form a film, and the formed bind material has a high strength and a high adhesive force, thereby further increasing the adhesive force of the binder material.

The weight percentage of each monomer in the whole monomers=mass of each monomer÷(mass of styrene monomer+mass of acrylic ester monomer+mass of acrylic acid monomer)×100%. For example, the weight percentage of styrene monomer in the whole monomers=mass of styrene monomer÷(mass of styrene monomer+mass of acrylic ester monomer+mass of acrylic acid monomer)×100%.

In an embodiment, the negative active material is at least one selected from a group consisting of graphite, meso carbon micro bead, hard carbon, soft carbon, Li₄Ti₅O₁₂, stannum and silicon. Preferably, the negative active material is graphite. In an embodiment, a weight percentage of the negative active material in the negative material layer is not less than 90%. Preferably, the weight percentage of the negative active material in the negative material layer is not less than 95%.

A person skilled in the art may select the suitable type of the conductive agent and the suitable content of the conductive agent according to actual demand. In an embodiment, the conductive agent is one selected from a group consisting of conductive carbon black, graphene and carbon nano-tube. In an embodiment, a weight percentage of the conductive agent in the negative material layer is 0˜3%. Preferably, the weight percentage of the conductive agent in the negative material layer is 0˜1.5%.

A person skilled in the art may select the suitable type of the thickening agent and the suitable content of the thickening agent according to actual demand. In an embodiment, the thickening agent is selected from carboxy methyl cellulose sodium and/or polyacrylamide. In an embodiment, a weight percentage of the thickening agent in the negative material layer is 0.8˜3%. Preferably, the weight percentage of the thickening agent in the negative material layer is 0.8˜1.5%.

In an embodiment, the binder material further comprises emulsifier. A person skilled in the art may select the suitable type of the emulsifier and the suitable content of the emulsifier according to actual demand. In an embodiment, a weight percentage of the emulsifier in the binder material is 2˜5%. In an embodiment, the emulsifier is disproportionated rosin potassium soap and/or oleic acid potassium.

Moreover, the binder material further comprises inevitable polymerization chain initiator and chain terminator. A person skilled in the art may select the suitable type of the chain initiator and the suitable type of the chain terminator and the suitable content of the chain initiator and the suitable content of the chain terminator according to actual demand.

In an embodiment, preparation of the emulsion of the binder material before the emulsion of the binder material is cured comprises at least steps of: adding the styrene monomer, the acrylic ester monomer, the acrylic acid monomer into an aqueous solution containing the emulsifier, then adding the chain initiator to initiate the polymerization under a temperature not more than 30° C. to obtain an emulsion of the binder material with a solid content of 35 wt %˜55 wt %.

In a second aspect of the present disclosure, a lithium-ion battery is provided, which comprises the above negative material layer in the first aspect of the present disclosure. The lithium-ion battery has an excellent safety performance and an excellent cycle performance in the case of quick and high rate charge.

In an embodiment, the lithium-ion battery is a wound lithium-ion battery or a laminated lithium-ion battery.

The lithium-ion battery comprises a positive electrode plate, a negative electrode plate, a separator, a solid electrolyte or an electrolyte solution, the negative electrode plate comprises the above negative material layer in the first aspect of the present disclosure and a current collector.

The present disclosure has following beneficial effects:

(1) The binder material of the negative material layer of the present disclosure has an excellent adhesive force, a high ionic conductivity, thereby making the lithium-ion battery quickly charged under a high rate.

(2) The lithium-ion battery using the negative material layer of the present disclosure can avoid the lithium precipitation occurring on the surface of the negative electrode plate in the case of quick and high rate charge.

(3) The lithium-ion battery using the negative material layer of the present disclosure has an excellent safety performance and an excellent cycle performance.

### BRIEF DESCRIPTION OF THE FIGURES

FIG. 1 illustrated an electrochemical impedance spectroscopy of the lithium-ion battery C1 and the lithium-ion battery C9.

FIG. 2 illustrated cycle life of the lithium-ion battery C1 and the lithium-ion battery C9 under 2 C charging cycle.

### DETAILED DESCRIPTION

The present disclosure will be apparent through detailed description in combination with the figures and the examples, but the present disclosure is not limited to these figures and examples.

Ratio in the examples refers to weight part.

### Example 1

### (1) Preparation of the Emulsion of the Binder Material Before the Emulsion of the Binder Material was Cured

Distilled water with a weight part of 195, emulsifier (disproportionated rosin potassium soap) with a weight part of 2.25, emulsifier (oleic acid potassium) with a weight part of 2.25 were added into a polymerizing-kettle where the air was replaced with nitrogen. Then styrene monomer with a weight part of 15, butyl methacrylate monomer with a weight part of 41, ethyl acrylate monomer with a weight part of 41 and methacrylic acid monomer with a weight part of 3 were added into the polymerizing-kettle, the air in the polymerizing-kettle was replaced with nitrogen for 15 minutes. Chain initiator (ammonium persulphate) with a weight part of 0.9 was added into the polymerizing-kettle when the temperature of the polymerizing-kettle was controlled at 5˜10° C. to obtain the emulsion of the binder material, and the agitator speed was controlled at 100 r/min, the polymerization time was 8 hours.

### (2) Preparation of the Negative Electrode Plate N1

Negative active material (artificial graphite), the emulsion of the binder material, thickening agent (carboxy methyl cellulose sodium), conductive agent (conductive carbon black) were uniformly mixed to obtain a mixture containing the negative active material after a high speed mixing. In the mixture, solid compositions were artificial graphite with a content of 95 wt %, carboxy methyl cellulose sodium with a content of 1.5 wt %, conductive carbon black with a content of 1.5 wt %, the emulsion of the binder material with a content of 2 wt %. Solvent (distilled water) was added into the mixture to obtain a negative active material slurry, in the slurry, the solid content was 50 wt %. Then the slurry was uniformly coated on two surfaces of current collector (copper foil), which was then dried and pressed by a rolling machine to form a negative electrode plate which was marked as N1.

### (3) Preparation of Positive Electrode Plate P1

Positive active material (lithium cobalt oxide (LiCoO₂)), binder material (polyvinylidene fluoride (PVDF), conductive agent (conductive carbon black) were uniformly mixed to obtain a mixture containing the positive active material after a high speed mixing. In the mixture, solid compositions were lithium cobalt oxide with a content of 90 wt %, PVDF with a content of 5 wt % and conductive carbon black with a content of 5 wt %. Solvent (N-methyl pyrrolidone (NMP)) was added into the mixture to obtain a positive active material slurry, in the slurry, the solid content was 75 wt %. Then the slurry was uniformly coated on two surfaces of current collector (aluminum foil), which was then dried and pressed by a rolling machine to form a positive electrode plate which was marked as P1.

### (4) Preparation of Lithium-Ion Battery C1

Conductive tabs were respectively soldered on the positive electrode plate P1 and the negative electrode plate N1, a polypropylene/polyethylene composite separator (PP/PE composite separator) with a thickness of 14 μm was interposed between the positive electrode plate and the negative electrode plate, then the positive electrode plate, the negative electrode plate and the separator were wound together to form a cell, which was then packaged with an aluminum foil. The electrolyte solution was an electrolyte solution of lithium hexafluorophosphate with a concentration of 1M, the solvent was a mixture of ethylene carbonate, dimethyl carbonate and 1,2-propylene carbonate with a volume ratio of 1:1:1. Then the cell was followed by injecting the electrolyte, formation and aging to obtain a rectangular soft package lithium-ion battery with a dimension of 32 mm×82 mm×42 mm which was marked as C1.

### Example 2

Preparation of the emulsion of the binder material before the emulsion of the binder material was cured was the same as that in example 1 except the following difference: the monomers comprised styrene monomer with a weight part of 12, butyl methacrylate monomer with a weight part of 42, ethyl acrylate monomer with a weight part of 43 and methacrylic acid monomer with a weight part of 3.

Preparation of the negative electrode plate was the same as that in example 1 except the following difference: in the slurry of the mixture, the solid compositions were artificial graphite with a content of 96 wt %, carboxy methyl cellulose sodium with a content of 1.5 wt %, conductive carbon black with a content of 1.5 wt %, binder material with a content of 1 wt %. The obtained negative electrode plate was marked as N2.

Preparation of lithium-ion battery was the same as that in example 1 except that P1 was the positive electrode plate, N2 was the negative electrode plate, the obtained lithium-ion battery was marked as C2.

### Example 3

Preparation of the emulsion of the binder material before the emulsion of the binder material was cured was the same as that in example 1 except the following difference: in the preparing process of the emulsion of the binder material before the emulsion of the binder material was cured, the monomers comprised styrene monomer with a weight part of 25, methyl acrylate monomer with a weight part of 36, butyl acrylate monomer with a weight part of 36 and methacrylic acid monomer with a weight part of 3.

Preparation of the negative electrode plate was the same as that in example 1 except that the obtained negative electrode plate was marked as N3.

Preparation of lithium-ion battery was the same as that in example 1 except that P1 was the positive electrode plate, N3 was the negative electrode plate, the obtained lithium-ion battery was marked as C3.

### Example 4

Preparation of the emulsion of the binder material before the emulsion of the binder material was cured was the same as that in example 1 except the following difference: in the preparing process of the emulsion of the binder material before the emulsion of the binder material was cured, the monomers comprised styrene monomer with a weight part of 15, methyl acrylate monomer with a weight part of 39, butyl acrylate monomer with a weight part of 39, acrylic acid monomer with a weight part of 3, ethacrylic acid monomer with a weight part of 4.

Preparation of the negative electrode plate was the same as that in example 1 except that the obtained negative electrode plate was marked as N4.

Preparation of lithium-ion battery was the same as that in example 1 except that P1 was the positive electrode plate, N4 was the negative electrode plate, the obtained lithium-ion battery was marked as C4.

### Example 5

Preparation of the emulsion of the binder material before the emulsion of the binder material was cured was the same as that in example 1 except the following difference: in the preparing process of the emulsion of the binder material before the emulsion of the binder material was cured, the monomers comprised styrene monomer with a weight part of 10, butyl methacrylate monomer with a weight part of 50, ethyl acrylate monomer with a weight part of 34, acrylic acid monomer with a weight part of 5.

Preparation of the negative electrode plate was the same as that in example 1 except that the obtained negative electrode plate was marked as N5.

Preparation of lithium-ion battery was the same as that in example 1 except that P1 was the positive electrode plate, N5 was the negative electrode plate, the obtained lithium-ion battery was marked as C5.

### Example 6

Preparation of the emulsion of the binder material before the emulsion of the binder material was cured was the same as that in example 1 except the following difference: in the preparing process of the emulsion of the binder material before the emulsion of the binder material was cured, the monomers comprised styrene monomer with a weight part of 35, ethyl acrylate monomer with a weight part of 60, ethacrylic acid monomer with a weight part of 5.

Preparation of the negative electrode plate was the same as that in example 1 except that the obtained negative electrode plate was marked as N6.

Preparation of lithium-ion battery was the same as that in example 1 except that P1 was the positive electrode plate, N6 was the negative electrode plate, the obtained lithium-ion battery was marked as C6.

### Example 7

Preparation of the emulsion of the binder material before the emulsion of the binder material was cured was the same as that in example 1 except the following difference: in the preparing process of the emulsion of the binder material before the emulsion of the binder material was cured, the monomers comprised styrene monomer with a weight part of 40, butyl methacrylate monomer with a weight part of 25, ethyl acrylate monomer with a weight part of 8, methyl acrylate monomer with a weight part of 7, butyl acrylate monomer with a weight part of 10, acrylic acid monomer with a weight part of 3, methacrylic acid monomer with a weight part of 3, ethacrylic acid monomer with a weight part of 4.

Preparation of the negative electrode plate was the same as that in example 1 except that the obtained negative electrode plate was marked as N7.

Preparation of lithium-ion battery was the same as that in example 1 except that P1 was the positive electrode plate, N7 was the negative electrode plate, the obtained lithium-ion battery was marked as C7.

### Example 8

Preparation of the emulsion of the binder material before the emulsion of the binder material was cured was the same as that in example 1 except the following difference: in the preparing process of the emulsion of the binder material before the emulsion of the binder material was cured, the monomers comprised styrene monomer with a weight part of 18, ethyl methacrylate monomer with a weight part of 51, butyl acrylate monomer with a weight part of 30, acrylic acid monomer with a weight part of 0.5, ethacrylic acid monomer with a weight part of 0.5.

Preparation of the negative electrode plate was the same as that in example 1 except that the obtained negative electrode plate was marked as N8.

Preparation of lithium-ion battery was the same as that in example 1 except that P1 was the positive electrode plate, N8 was the negative electrode plate, the obtained lithium-ion battery was marked as C8.

### Comparative Example 1

It was the same as that in example 1 except the following difference: the preparing process of the emulsion of the binder material was omitted, in the preparation of the negative electrode plate, the binder material was the conventional styrene-butadiene rubber (SBR) binder material, the obtained negative electrode plate was marked as N9.

Preparation of lithium-ion battery was the same as that in example 1 except that P1 was the positive electrode plate, N9 was the negative electrode plate, the obtained lithium-ion battery was marked as C9.

Testing of the Adhesive Force of the Negative Electrode Plates

The negative electrode plates N1˜N9 each were positioned on a AI-3000 high speed railway tensile testing machine to test the adhesive force of each of the negative electrode plates N1˜N9 after a cold pressing. Then the negative electrode plates N1˜N9 were immersed in the electrolyte solution for 96 hours at a temperature of 60° C., a second test of the adhesive force of each of the negative electrode plates N1˜N9 was conducted. The electrolyte solution comprised an electrolyte of lithium hexafluorophosphate with a concentration of 1M, and a solvent of a mixture of ethylene carbonate, dimethyl carbonate and 1,2-propylene carbonate with a volume ratio of 1:1:1.

Type of the monomer of the binder material, weight percentage of the monomer in the whole monomers, and test results of the adhesive force of each of the negative electrode plates N1˜N9 were illustrated in Table 1. It could be seen from Table 1, the adhesive force of the negative electrode plates N1˜N8 using the negative material layer of the present disclosure was significantly improved compared with the adhesive force of the negative electrode plate N9 of comparative example 1.

Testing of the Lithium Precipitation on the Surface of the Negative Electrode Plates

At 25° C., each of the lithium-ion batteries C1˜C8 of examples 1˜8 and the lithium-ion battery C9 of comparative example 1 was charged to 4.35V at a constant current of 2 C, then the lithium-ion battery was charged to 0.05 C at a constant voltage of 4.35V, then the lithium-ion battery was discharged to 3V at a constant current of 1 C, which was a charge-discharge cycle, and the charge-discharge cycle was repeated for 10 times. Each of the lithium-ion batteries C1˜C9 was full charged after 10 charge-discharge cycles, then the each lithium-ion battery was disassembled to test the extent of lithium precipitation on the surface of the negative electrode plate with an IRIS Advantage inductively coupled plasma (ICP), test results were illustrated in Table 2.

Testing of the Electrochemical Impedance Scanning

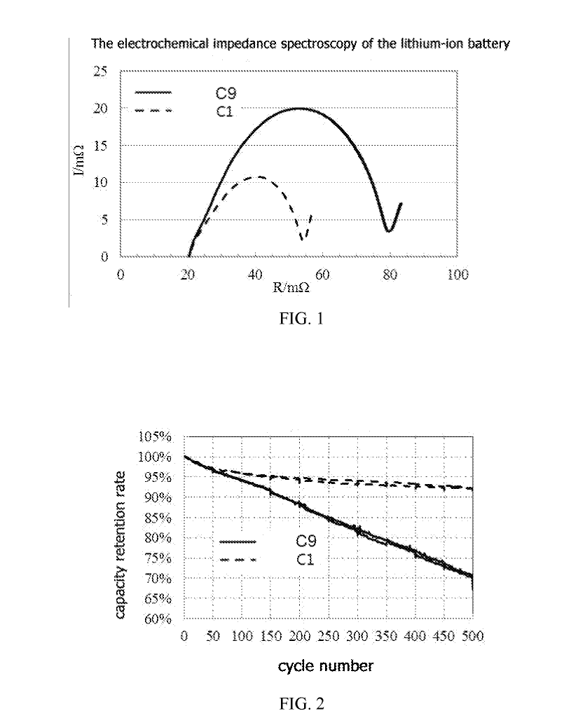

Each of the lithium-ion batteries C1˜C8 of examples 1˜8 and the lithium-ion battery C9 of comparative example 1 was tested with an IM6ex electrochemical work station to scan the electrochemical impedance at normal temperature and under a half-full charge. The lithium-ion battery C1 was a typical representative of the lithium-ion batteries C1˜C8 of the present disclosure, the electrochemical impedance spectroscopy of the lithium-ion battery C1 and the electrochemical impedance spectroscopy of the lithium-ion battery C9 of comparative example 1 were illustrated in FIG. 1. It could be seen from FIG. 1, the conduction velocity of the lithium ions in the negative electrode plate of the lithium-ion battery C1 was significantly improved compared with the lithium-ion battery C9.

Testing of the Cycle Performance of the Lithium-Ion Batteries

At 25° C., each of the lithium-ion batteries C1˜C8 of examples 1˜8 and the lithium-ion battery C9 of comparative example 1 was charged to 4.35V at a constant current of 2 C, then the lithium-ion battery was charged to 0.05 C at a constant voltage of 4.35V, then the lithium-ion battery was discharged to 3V at a constant current of 1 C, which was a charge-discharge cycle, the charge-discharge cycle was repeated for 500 times.

The n^{th} capacity retention rate (%)=(the discharge capacity after n cycles/the discharge capacity after the first cycle)×100%.

The lithium-ion battery C1 was a typical representative of the lithium-ion batteries C1˜C8 of the present disclosure, the capacity retention rate of the lithium-ion battery C1 and the capacity retention rate of the lithium-ion battery C9 of comparative example 1 were illustrated in FIG. 2 during the cycle process. When the lithium-ion batteries were under the same cycle, the capacity retention rate of each of the lithium-ion batteries C2˜C8=the capacity retention rate of the lithium-ion battery C1×(1±10%).

It could be seen from FIG. 2, the cycle life of the lithium-ion battery C1 of the present disclosure was significantly improved compared with the lithium-ion battery C9.

The examples are only the preferred examples of the present disclosure, and the present disclosure is not limited to that, modifications and variations of the present disclosure can occur to a person skilled in the art. Modifications, equivalent replacements, variations and the like within the spirit and scope of the present disclosure will be within the scope of the appended claims.

TABLE 1

| | weight | | | | adhesive | adhesive force |
|---|---|---|---|---|---|---|
| | percentage | weight | | | force after | after immersed |
| number of the | (%) of the | percentage(%) | type and weight percentage | type and weight | a cold | in the |
| negative | styrene | of the butadiene | (%) of the acrylic ester | percentage (%) of the | pressing | electrolyte |
| electrode plate | monomer | monomer | monomer | acrylic acid monomer | (N/m) | solution (N/m) |
| N1 | 15 | 0 | butyl methacrylate, 41 | methacrylic acid, 3 | 30 | 25 |
| | | | ethyl acrylate, 41 | | | |
| N2 | 12 | 0 | butyl methacrylate, 42 | methacrylic acid, 3 | 35 | 20 |
| | | | ethyl acrylate, 43 | | | |
| N3 | 25 | 0 | methyl acrylate, 36 | methacrylic acid, 3 | 24 | 18 |
| | | | butyl acrylate, 36 | | | |
| N4 | 15 | 0 | methyl acrylate, 39 | acrylic acid, 3 | 34 | 24 |
| | | | butyl acrylate, 39 | ethacrylic acid, 4 | | |
| N5 | 10 | 0 | butyl methacrylate, 50 | acrylic acid, 5 | 35 | 18 |
| | | | ethyl acrylate, 34 | | | |
| N6 | 35 | 0 | ethyl acrylate, 60 | ethacrylic acid, 5 | 20 | 16 |
| N7 | 40 | 0 | butyl methacrylate, 25 | acrylic acid, 3 | 19 | 16 |
| | | | ethyl acrylate, 8 | methacrylic acid, 3 | | |
| | | | methyl acrylate, 7 | ethacrylic acid, 4 | | |
| | | | butyl acrylate, 10 | | | |
| N8 | 18 | | butyl acrylate, 30 | ethacrylic acid, 0.5 | 28 | 17 |
| | | | ethyl methacrylate, 51 | acrylic acid, 0.5 | | |
| N9 | 15 | 85 | 0 | 0 | 20 | 12 |

TABLE 2

| number of the battery | lithium precipitation |
|---|---|
| C1 | none |
| C2 | none |
| C3 | slight lithium precipitation |
| C4 | none |
| C5 | none |
| C6 | slight lithium precipitation |
| C7 | slight lithium precipitation |
| C8 | none |
| C9 | serious lithium precipitation |

What is claimed is:

1. A negative material layer, comprising negative active material, conductive agent, binder material and thickening agent,
a weight percentage of the binder material in the negative material layer being not more than 2%;
the binder material comprising a polymer polymerized from a styrene monomer, an acrylic ester monomer and an acrylic acid monomer.

2. The negative material layer according to claim 1, wherein the acrylic ester monomer has a chemical structural formula illustrated in formula (I), the acrylic acid monomer has a chemical structural formula illustrated in formula (II); 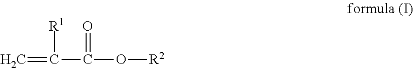
in formula (I), R¹ is selected from H or alkyl group having 1˜20 carbon atoms; R² is selected from alkyl group having 1˜20 carbon atoms; 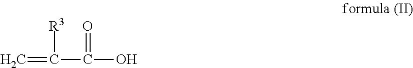
in formula (II), R³ is selected from H or alkyl group having 1˜20 carbon atoms.

3. The negative material layer according to claim 1, wherein the acrylic ester monomer is at least one select from a group consisting of methyl acrylate, ethyl acrylate, butyl methacrylate and butyl acrylate; the acrylic acid monomer is at least one select from a group consisting of acrylic acid, methacrylic acid and ethacrylic acid.

4. The negative material layer according to claim 1, wherein
a weight percentage of the styrene monomer in the whole monomers is 10˜40%;
a weight percentage of the acrylic ester monomer in the whole monomers is 50˜85%;
a weight percentage of the acrylic acid monomer in the whole monomers is 1˜10%.

5. The negative material layer according to claim 1, wherein the negative active material is at least one selected from a group consisting of graphite, meso carbon micro bead, hard carbon, soft carbon, Li₄Ti₅O₁₂, stannum and silicon.

6. The negative material layer according to claim 1, wherein the negative active material is at least one selected from a group consisting of natural graphite, artificial graphite, meso carbon micro bead, hard carbon, soft carbon, Li₄Ti₅O₁₂, stannum and silicon.

7. The negative material layer according to claim 1, wherein the conductive agent is at least one selected from a group consisting of conductive carbon black, graphene and carbon nano-tube.

8. The negative material layer according to claim 1, wherein the thickening agent is selected from carboxy methyl cellulose sodium and/or polyacrylamide.

9. The negative material layer according to claim 1, wherein the weight percentage of the binder material in the negative material layer is 0.5˜2%.

10. A lithium-ion battery, comprising a negative material layer,
the negative material layer comprising negative active material, conductive agent, binder material and thickening agent,
a weight percentage of the binder material in the negative material layer being not more than 2%;
the binder material comprising a polymer polymerized from a styrene monomer, an acrylic ester monomer and an acrylic acid monomer.

11. The lithium-ion battery according to claim 10, wherein the acrylic ester monomer has a chemical structural formula illustrated in formula (I), the acrylic acid monomer has a chemical structural formula illustrated in formula (II); 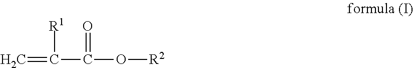
in formula (I), R¹ is selected from H or alkyl group having 1˜20 carbon atoms; R² is selected from alkyl group having 1˜20 carbon atoms; 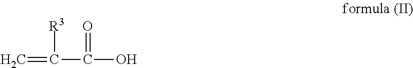
in formula (II), R³ is selected from H or alkyl group having 1˜20 carbon atoms.

12. The lithium-ion battery according to claim 10, wherein the acrylic ester monomer is at least one select from a group consisting of methyl acrylate, ethyl acrylate, butyl methacrylate and butyl acrylate; the acrylic acid monomer is at least one select from a group consisting of acrylic acid, methacrylic acid and ethacrylic acid.

13. The lithium-ion battery according to claim 10, wherein
a weight percentage of the styrene monomer in the whole monomers is 10˜40%;
a weight percentage of the acrylic ester monomer in the whole monomers is 50˜85%;
a weight percentage of the acrylic acid monomer in the whole monomers is 1˜10%.

14. The lithium-ion battery according to claim 10, wherein the negative active material is at least one selected from a group consisting of graphite, meso carbon micro bead, hard carbon, soft carbon, Li₄Ti₅O₁₂, stannum and silicon.

15. The lithium-ion battery according to claim 10, wherein the negative active material is at least one selected from a group consisting of natural graphite, artificial graphite, meso carbon micro bead, hard carbon, soft carbon, Li₄Ti₅O₁₂, stannum and silicon.

16. The lithium-ion battery according to claim 10, wherein the conductive agent is at least one selected from a group consisting of conductive carbon black, graphene and carbon nano-tube.

17. The lithium-ion battery according to claim 10, wherein the thickening agent is selected from carboxy methyl cellulose sodium and/or polyacrylamide.

18. The lithium-ion battery according to claim 10, wherein the weight percentage of the binder material in the negative material layer is 0.5˜2%.
